(19) United States
(12) Patent Application Publication
(10) Pub. No.: US 2026/0229122 A1
(43) Pub. Date: Aug. 6, 2026

(54) REAL-TIME PARKING LOCATION DIMENSION, OBSTRUCTION, AND RESTRICTION INFORMATION AND SYSTEMS AND METHODS FOR MANAGING THE SAME

(71) Applicant: Toyota Jidosha Kabushiki Kaisha, Toyota-shi Aichi-ken (JP)

(72) Inventor: Alexander Granieri, Mountain View, CA (US)

(73) Assignee: Toyota Jidosha Kabushiki Kaisha, Toyota-shi Aichi-ken (JP)

(21) Appl. No.: 19/038,198

(22) Filed: Jan. 27, 2025

(51) Int. Cl. G08G 1/14; G06V 20/58; H04W 4/44

(52) U.S. Cl. CPC G08G 1/145; G06V 20/582; G06V 20/586; H04W 4/44

(57) ABSTRACT

A system, method, and participating vehicle for managing parking availability in an area are disclosed. The system includes a parking system configured to receive sensor data transmitted by one or more vehicles which relate to parking availability in an area and the effective size of parking locations, such as due to obstructions, relative to an expected size of those locations. With this information, the parking system can, in real time, provide parking availability information to incoming vehicles based on whether those incoming vehicles will fit within the effective size of the parking locations, thereby increasing the utilization of parking locations which may be only partially blocked or which may have additional room which may not be reflected by standard parking location dimensions.

### TECHNICAL FIELD

Embodiments described herein generally relate to parking assistance systems for manually and/or autonomously driven vehicles as well as networks involving the same.

### BACKGROUND

Integrating parking assistance into traditional navigation or trip planning systems is often problematic because, unlike real-time traffic data, real-time parking information is rarely available. Even if one is able to identify on a map where parking areas, such as parking garages, parking lots, on-street parking, and the like, may be located, there is often no information at hand with respect to whether those parking areas actually have spots available in which a vehicle may be parked – at least until one reaches the parking area and can see firsthand for oneself. It may also be unclear what costs may be involved when parking in a given parking area, whether time-dependent pricing may be involved, and/or whether time-dependent parking rules or regulations affect parking availability.

Additionally, simply tracking a given parking location as available or unavailable, or in some other, similar binary manner, neglects the different sizes and/or needs of various vehicles that may wish to park in that location. For instance, a parking location may be unavailable to an oversized truck but still available to a motorcycle, and thus simply marking the location as unavailable would prevent the motorcycle rider from learning that the parking location could be utilized.

As a result, this failure of navigation systems to address the parking portion of a trip may cause great uncertainty and stress for drivers and passengers alike. This lack of transparency also affects the owners/operators of parking facilities, as there are few options available by which these owners/operators might increase the utilization of their facilities. If parking spots have recently become available, will soon become available, or are only available to a certain subset of vehicles, the owners/operators of these facilities have no way to communicate this information to incoming drivers and/or to attract drivers to the parking facility.

Thus, new configurations, systems, and methods may be desired to increase the transparency regarding parking availability, thereby alleviating stress for drivers and increasing utilization for owners/operators of parking facilities.

### SUMMARY

In one embodiment, a system for managing parking availability includes a parking system which includes at least one processor and which is configured to store information relating to a first parking location, the information comprising at least an expected size of the first parking location; receive update information relating to an effective size of the first parking location; and transmit to a first vehicle an availability of the first parking location based on the effective size.

In another embodiment, a method for managing parking availability includes storing information relating to a first parking location, the information comprising at least an expected size of the first parking location; receiving update information relating to an effective size of the first parking location; and transmitting to a first vehicle an availability of the first parking location based on the effective size.

In another embodiment, a vehicle which interacts with a parking system includes at least one sensor, wherein the vehicle is configured to use the at least one sensor to scan an environment around the vehicle to ascertain parking-related information and/or parking availability and transmit the sensor data to the parking system.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a block diagram depicting an exemplary system including a parking system according to one or more embodiments described and/or illustrated herein;

FIG. 2 schematically depicts an exemplary parking management scenario according to one or more embodiments described and/or illustrated herein; and

FIG. 3 depicts an exemplary flow chart relating to a method for managing parking availability according to one or more embodiments described and/or illustrated herein.

### DETAILED DESCRIPTION

Embodiments of the disclosure herein provide for an improved parking system which leverages network-based solutions to, in real time: identify parking availability, supplement an expected parking availability with an actual parking availability, and/or convey information relating to parking availability to vehicles.

This overall scheme is achieved, in part, by using one or more sensors provided on-board a vehicle to ascertain the availability of parking as sensed by the vehicle, by transmitting information relating to parking availability to a server, and by making the parking availability information accessible to other vehicles by way of the server. The information made available by the server may then be used in the various embodiments to assist in trip planning and/or navigation, improving trip travel times, improving walking times, and/or improving parking spot utilization, and the like.

Embodiments disclosed herein may, additionally or alternatively, consider information such as parking metadata (e.g., how long a vehicle has been parked in a given spot, what the typical parking time for a spot is), information affecting the size of a given parking location (e.g., sensor data describing an obstruction of some or all of a parking location which reduces the available parking space or an environment which suggests a larger parking space than expected), information incident on parking usage (e.g., point of sale information/interactions, event start/end times, user searches on a mobile device for nearby activities/locations), signage affecting parking availability (e.g., no parking signs, limited parking signs, temporary parking signs acting with or in place of “permanent” parking signs, residential or other badging displayed on vehicles currently parked in a given location), trip-based information (e.g., navigation to/from the parking facility and/or a location near to the parking facility), and the like to assist in the prediction and management of parking availability.

The term “occupant,” as used herein, may refer to any of drivers, passengers, persons (such as fleet managers, coordinators, dispatchers, and the like), and/or autonomous vehicle control stacks which are associated with a given vehicle. Except where explicitly indicated otherwise, “occupant” is not to be limited with respect to whether said person is currently occupying a vehicle (e.g., a passenger who exits a vehicle to go see a movie is still considered an occupant of the vehicle while they are sitting in the theater and the vehicle is parked outside). In situations concerning fleet vehicles, autonomous vehicles, or similar, “occupant” may simultaneously refer to both a driver of a vehicle and a dispatcher. In other scenarios, “occupant” may simultaneously refer to both a passenger and an autonomous vehicle control stack. In other words, messages, responses, messaging, notifications, and the like may be sent to/from/between all entities embodying “occupant” as may be relevant to the presented scenario.

The term “vehicle,” as used herein, may refer to any car, truck, motorcycle, van, scooter, or the like, without limit, used in the course of personal, recreational, or commercial transportation. Aerial, aquatic, off-road, and/or industrial vehicles are also contemplated. The vehicle may be manually driven by an occupant, semi-autonomously driven, or fully autonomous, at any level of automation, such as that defined by the Society of Automotive Engineers (SAE) J31016 standard levels 0 through 5.

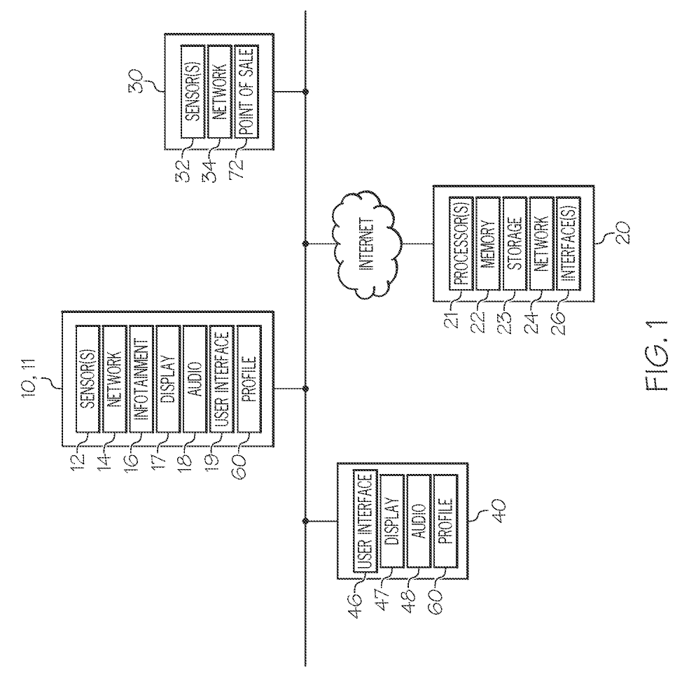

Turning now to FIG. 1, vehicle 10 may be provided with one or more sensors 12 for detecting the environment around the vehicle. Sensors 12 may include cameras or visual light sensors, infrared/ultraviolet cameras/sensors, radar emitters/detectors, ultrasonic emitters/detectors, LiDAR scanners, microwave emitters/detectors, time-of-flight scanners/detectors, and any other similar or comparable scanner or detector which is capable of taking measurements of an environment at a distance. The one or more sensors 12 may also include devices such as GPS sensors or sensors of other satellite-position based technologies, clocks/timers, and the like necessary to facilitate operation of the vehicle 10 and/or other sensors 12.

Each vehicle 10 may also be provided with one or more network interfaces 14, such as cellular data interfaces (e.g., 3G, 4G, 5G, LTE, GSM, without limitation), satellite uplinks and/or modems, WiFi, Bluetooth, ZigBee, Z-wave, RFID, and the like by which the vehicle may communicate, directly or indirectly, with a parking system 20. The vehicle 10 may further be provided with any processors, memory units, computer storage units, user interfaces, application-specific integrated circuits (ASICs), and the like necessary to establish communication with the parking system 20, to facilitate user interaction with systems of the vehicle 10 and/or the parking system 20, to operate the one or more sensors 12 provided on-board the vehicle, and/or to conduct any intermediate operations in facilitation of the same.

Each vehicle 10 may also be provided with an infotainment system 16 through which any of a radio or sound system, navigational system, climate control system, and the like may be manipulated by an occupant of the vehicle. Each vehicle 10 may also be provided with, as part of or in addition to those elements of the infotainment system 16, display devices 17, audio devices 18 and/or user interfaces 19 for communicating with and/or exchanging inputs with the occupant. For example, display devices 17 may include any of dashboard displays, infotainment displays, heads-up displays, projected displays, screens, and the like without limitation. Audio devices 18 may include any of speakers, microphones, audio out ports (such as a headphone jack), Bluetooth connected audio, and the like without limitation. User interfaces 19 may include any of touchscreens, keyboards, buttons, dials, levers, microphones, and the like without limitation.

Infotainment system 16 may be operatively coupled to, in connection with, or in communication with any of the processors, memory, storage interfaces, etc. discussed above and/or may include or correspond to the processors/memory, storage interfaces, etc. discussed above.

The parking system 20 may be embodied as a server, a networked and/or Internet-accessible database, a cloud-computing platform, a website, a repository, an app-delivery platform, or any other suitable computing device remote to the vehicles 10 and/or infrastructure systems 30. However, it is contemplated that parking system 20 may also be part of a given infrastructure system 30 or vice versa. Parking system 20 may include any processors 21, memory units 22, computer storage units 23, user interfaces 26 (such as displays, audio systems, user input devices, and the like), network interfaces 24, ASICs, and the like to carry out functions relating to normal operation and/or to carry out and/or facilitate those methods and procedures set forth herein further to those descriptions set forth above.

One or more infrastructure systems 30 may be provided, such as parking meters, parking lot or parking facility access control systems, and/or parking management systems. Each infrastructure system 30 may likewise be provided with one or more sensors 32 further to the descriptions set forth above, one or more network interfaces 34 further to the descriptions set forth above, and any processors, memory units, computer storage units, user interfaces, displays, audio systems, ASICs, and the like to carry out functions relating to normal operation and/or to carry out and/or facilitate those methods and procedures set forth herein further to those descriptions set forth above.

Occupants of the vehicles may have mobile devices 40, such as smartphones, feature phones, tablets, smartwatches, palm devices, and/or the like, which may be operatively coupled to, in connection with, or in communication with any of the systems of the one or more vehicles 10, parking system 20, and/or infrastructure system 30. Similar to the above, mobile devices 40 may include: user interfaces 46 such as touch screens and/or buttons; display screens 47; audio systems 48 such as speakers, audio out ports, and/or Bluetooth connected audio; and the like which permit the occupants of the vehicles to interact with the mobile devices 40 and/or permit the mobile devices 40 to communicate or otherwise provide information to the occupants of the vehicles. In those embodiments in which an occupant is an autonomous vehicle stack, mobile devices 40 may be embodied by the relevant computer hardware associated with the autonomous vehicle.

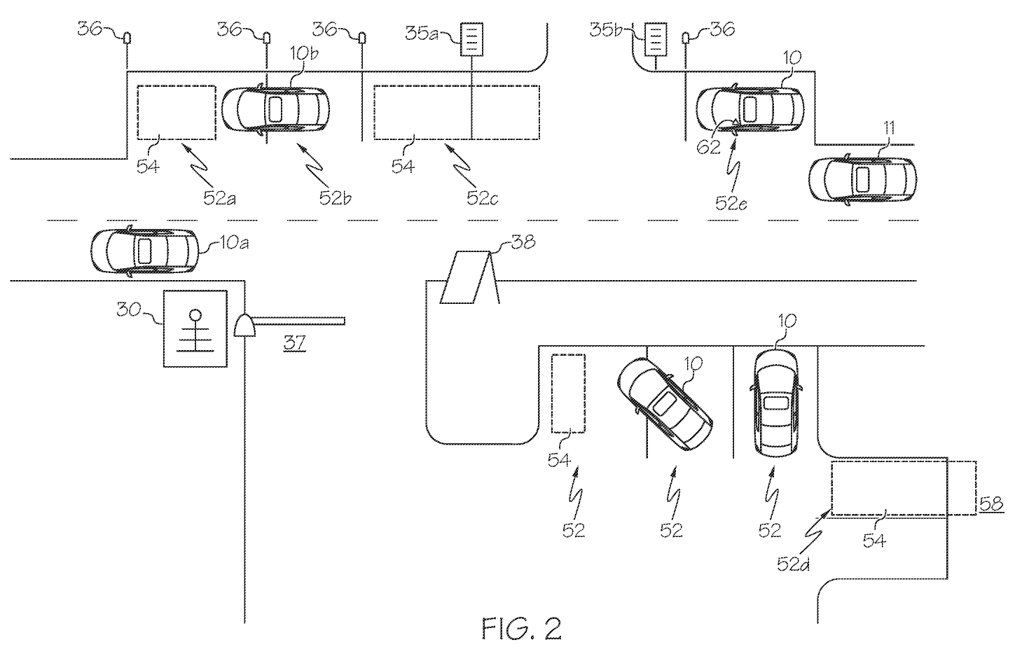

Referring now to FIGS. 1-2, as one or more of the vehicles 10 drive through an area, the sensors 12 of the vehicles are used to scan the environment of the area to detect available parking locations 52.

Detection of available parking location 52 may be achieved through the collection of dimensional data, depth data, depth maps, point clouds, and the like from which can be identified parameters such as how wide a shoulder or a parking lane of the road is, whether cars are currently parked on that shoulder, what the distance is between cars parked on the shoulder, the presence/dimensions of any curbs, drop-offs, obstructions, driveways, sidewalks, and the like. Detection may also include, such as (but not limited to) when driving through a parking lot or parking garage, collection of dimensional data regarding the size of parking spots, distances between cars, whether cars are parked in a given spot, whether there is enough room for another car in a given spot (e.g., due to another car not parking within established lines).

Detection of available parking spots may be achieved visually, such as with a camera, from which the dimensional data/etc. discussed above might be derived. Additionally or alternatively, visual detection of available parking spaces may include the imaging and subsequent detection of indicators like parking-related signage 35, parking meters 36, parking lot entryways 37, parking lot display signage 38 (e.g., “lot full” signs, “event parking only” signs, “monthly parking only” signs, and/or signs that display how many spots remain in a given lot/garage and/or on a given level of said lot/garage), and the like.

Detection of available parking spots may be achieved by the transmission of signals from one or more infrastructure systems 30 to the vehicle 10, such as by parking meters broadcasting a signal that time has expired, a signal indicating the time remaining for a given parking session, a signal that no vehicle is currently parked in a spot, a signal directly indicating pricing information, and/or a signal indicating a parking zone, spot number or the like which facilitates the looking up of pricing information for a spot. Likewise an infrastructure system 30 for a parking lot/garage may broadcast information receivable by the vehicles relating to how many spots are available, pricing, and the like.

The parking system 20 may receive and make available the data transmitted to the parking system 20 by vehicles 10 and/or infrastructure systems 30 as-is. Additionally/alternatively, the parking system 20 may further process the data received from the vehicles 10 and/or infrastructure systems to provide more in-depth parking availability information. Additionally/alternatively, the parking system 20 may have access to or otherwise be provided with additional data relating to parking availability that may or may not originate from any of the vehicles 10 or infrastructure systems 30. Examples of this additional data may include maps of an area, such as city/state maps, roadway maps, topographical maps, mapping information relating to addresses, names of properties/stores/establishments, and the like. This additional data may be combined with, supplement, or otherwise be used with the data received from vehicles 10 and/or infrastructure systems 30 as needed to convey relevant information to the vehicles 10 and any subsequent vehicles 11.

For example, a given infrastructure system 30 for a parking garage may only provide to the parking system 20 the number of available parking spots and a typical hourly/daily rate for parking. With the addition of sensor data provided by vehicles 10 driving past/through the garage, the parking system 20 may be able to provide to a subsequent vehicle 11: information describing where the available spots are located (e.g., of twenty-five available spots, five are available on level three and twenty are available on level four); a detailed map of the interior of the garage, including markers for elevator and/or stair access; indications that parking spots are only available at special event pricing instead of typical hourly/daily rates; and the like.

As another example, a given infrastructure system 30 for a parking meter may be reporting to the parking system 20 that a spot is occupied, but one or more vehicles 10 passing by the spot corresponding to the meter may identify that the spot is open or otherwise available. The one or more vehicles may optionally further detect and report to the parking system 20 that there is no signage modifying typical parking times/availability. As a result, the parking system 20 may discern that the parking meter is malfunctioning by incorrectly reporting the spot as occupied, and thus the parking system 20 may account for this malfunction and indicate to subsequent vehicles 11 the availability of the meter.

Data collected by the sensors 12, 32 may readily provide information regarding parking availability or may be processed by any number of computational models, algorithms, artificial intelligence models, machine learning models, neural network models, and the like to ascertain parking availability. This processing may occur on-board the vehicles 10, at the infrastructure systems 30, and/or the raw sensor data may be transmitted to any of the parking system 20 and/or infrastructure systems 30 for processing.

As a subsequent vehicle 11 is navigating to a destination, the subsequent vehicle may regularly query the parking system 20 for information regarding parking availability at the destination. The rate at which these queries are transmitted to the parking system 20 may be constant or may increase the closer the subsequent vehicle 11 is to its destination. Likewise, the parking availability information transmitted to the subsequent vehicle 11 by the server may be constant or may increase in resolution the closer the subsequent vehicle 11 is to its destination.

A user profile 60 associated with the subsequent vehicle 11 may include occupant preferences regarding parking spaces, such as: pricing preferences, preferences for spot/facility type (e.g., open lots, garages, valet parking, on-street parking, covered/uncovered), preferences regarding distances to a planned destination, and/or relationships correlating/linking/among the same (e.g., higher prices are acceptable closer to a destination, but not farther from the destination). When querying the parking system 20 for parking availability, the subsequent vehicle 11 may include with this query the user profile 60 so that the parking system 20 may filter parking availability accordingly. Additionally/alternatively, the user profile 60 remains on-board the subsequent vehicle 11 and the subsequent vehicle 11 filters the parking availability information received from the parking system 20 according to the user profile 60 before displaying the information to the occupant.

Even if a parking spot is not currently available, the parking system 20 may take into account the time remaining until the subsequent vehicle 11 reaches its destination in order to ascertain or otherwise predict what spots will become available by the time the subsequent vehicle 11 reaches its destination and requires a parking spot.

For example, if a given parking spot is associated with a two-hour parking limit, the parking system 20 is aware that a vehicle 10 has been parked in the spot for one hour, and the subsequent vehicle 11 is one or more hours away from its destination, the server may flag the parking spot as potentially available to the subsequent vehicle 11. At the same time, if an additional subsequent vehicle is only fifteen minutes away from that parking spot associated with the two hour-hour limit, the spot may be flagged as unavailable to the additional subsequent vehicle.

In another example, if an infrastructure system 30 such as a parking meter is reporting that only thirty minutes remain on the meter, the parking system 20 may transmit to any subsequent vehicles 11 that are more than thirty minutes away an indication that the spot will be available. If, however, more money is inserted into the meter, thereby extending the time for another hour, the server may update the indications of availability accordingly to the subsequent vehicles 11 based on travel times.

In another example, a corresponding infrastructure system 30 and/or the parking system 20 may, based on historical data, user-inputted data, event data (e.g., the duration of a concert or show), or the like establish an average parking time or an expected parking time for a given spot. When considering this average/expected parking time in addition to the amount of time a vehicle 10 has already been parked in a spot, the parking system 20 may transmit to the subsequent vehicle 11 parking availability information indicating that the spot will be available if the remaining travel time for the subsequent vehicle 11 is greater than the remaining average/expected parking time left for the vehicle 10.

The parking system 20 may further consider other requests received by and parking availability sent to other subsequent vehicles (e.g., if the parking system 20 tells a first subsequent vehicle 11 that a given parking spot will be available in twenty minutes, the parking system may flag this spot as unavailable to a second subsequent vehicle 11 in a similar time frame).

The parking system 20 may further evaluate parking availability based on an effective size 54 of a given parking location 52 in addition to or instead of an expected or recorded size of the given parking location 52 relative to a size of the subsequent vehicle 11.

For example, the parking system may store information that the expected length of one or more on-street parking locations 52 is twenty feet. However, sensor data from a passing vehicle 10a may show that another vehicle 10b has over-parked a set boundary line for one of these on-street parking locations 52, thus occupying two spaces instead of one. The parking system 20 may simply record that the vehicle 10b is parked in a first of these parking locations 52b and that a second of these parking locations 52a is unavailable due to an obstruction (namely, the over-parked vehicle 10b). Additionally or alternatively, the parking system may use the sensor data from the passing vehicle 10a to determine that the over-parked vehicle 10b has encroached upon the second of these parking locations 52a by two feet, reducing the available parking space in the second parking location 52a from an expected twenty feet in length to an effective eighteen feet in length.

When providing parking availability information to the subsequent vehicle 11, the parking system 20 may transmit to the subsequent vehicle 11 parking availability information which includes the effective size 54 or length of the parking location 52a so that the subsequent vehicle 11 may determine whether the parking location 52a is a viable parking location for the subsequent vehicle 11 given the size of the subsequent vehicle, information and/or preferences stored within a user profile 60, or the like. To continue the example, a subsequent vehicle 11 that requires twenty feet of length to park in a location will be told that parking location 52a is unavailable, whereas a subsequent vehicle that only requires 15 feet of length to park in a location will be told that parking location 52a is available.

Additionally/alternatively, when receiving an initial request for available parking locations from the subsequent vehicle 11, the parking system 20 may receive information from the subsequent vehicle 11 from which the parking system may, directly (e.g., the parking request includes the dimensions/size of the subsequent vehicle 11) or indirectly (e.g., the parking request includes the year, make, model number, vehicle identification number, and/or any other information that would enable the parking system 20 to look up or retrieve from an internal or third-party database the dimensions of the subsequent vehicle 11), derive the size of the subsequent vehicle 11. The parking system 20 may then filter, based on a determination as to whether the parking location 52a is a viable parking location given the size of the subsequent vehicle 11 and the effective size 54 of the parking location 52a, those possible parking locations which are ultimately sent to the subsequent vehicle 11 as parking availability information.

The exemplary use of a length of a given parking location 52 here is meant to be non-limiting, as the use/exchange of any dimensional data regarding the parking location 52 is contemplated. For instance, the expected size and/or the effective size 54 of the parking location 52 may be stored/considered as a length, width, and/or height of the parking location 52, in any combination; a bounding square, box, circle, sphere, oval or other suitable/preferable representative one-dimensional, two-dimensional, or three-dimensional shape which represents the parking location 52, in any combination of length/width/height or other dimensions; a full 3D representation, point cloud, or the like, of the parking location 52; and other similar representations. On-street (e.g., tree branches, garbage bins, other vehicles), off-street, and overhead (e.g., parking garage air vents) obstructions, without limit, may be accounted for by the effective size 54 of the parking location 52.

Additionally, the effective size 54 of a given parking location 52 is not limited to reductions in size relative to an expected size, and may include increases in size relative to an expected size of the parking location 52. For example, the subsequent vehicle 11 may be a large pickup truck that is longer than the expected size of a given parking location 52d. Yet, because the parking location 52d abuts a grassy or generally non-trafficked area 58, an effective size 54 greater than the expected size of the parking location 52d is available due to the fact that the pickup truck could back into the parking location 52d such that the tailgate of the truck overhangs this grassy/non-trafficked area 58 while the tires and front end of the truck remain within the expected bounds of the parking location. As another example, the boundary line of a parking location 52c may be drawn to a standard size, but additional space may exist beyond this boundary line where a vehicle may park without violating parking rules or regulations (e.g., additional space exists beyond the boundary of an on-street parking spot such that a subsequent vehicle 11 may exceed this boundary and still not block a driveway, adjacent spot, walkway, or the like).

Accordingly, by considering the effective size 54 of a given parking location 52 instead of or in addition to the expected/stored size of the given parking location 52, the system may achieve a greater utilization of parking resources by maintaining otherwise obstructed parking locations 52 or parking locations with greater than expected parking space within the pool of available parking locations. By considering sensor data provided by passing vehicles 10, these metrics may be dynamically updated in real time to reflect changing conditions of the given parking space 52 (e.g., someone may remove a branch or bin from the parking location, a bike may fall or be knocked over, an over-parked car may move and/or be replaced with a car that over-parks even worse, and so on).

Furthermore, sensor data from passing vehicles 10 may collect information regarding parking signage 35, such as “permanent” parking signs (e.g., the sort of metal no parking/etc. signs installed for long-term applicability) or “temporary” parking signs (e.g., the sort of parking signs, caution tape, and/or flagging which are set up for a temporarily for a one/multi-day event or the like) which may affect the availability of a given parking location. Passing vehicles 10 may capture images of these signs and, if necessary, composite multiple signs while preserving the order in which these signs appear and/or the position at which these signs appear so that the intended effect of compound signage can be appropriately considered.

For example, after turning onto a street, a vehicle 10 may detect a first parking sign 35b that says “No Parking” and includes an arrow pointing down the street, but no corresponding sign 35 which might indicate the end of the no parking zone is yet visible. The vehicle 10 may store this first image and, as the vehicle 10 continues down the street, detect the corresponding second parking sign 35a which says “No Parking” and includes an arrow pointing back towards the first sign 35b. By compositing these two signs, the vehicle 10 may discern that sign 35a and sign 35b denote a no parking zone between them. However, this determination may only be achieved if the original positioning and/or ordering of the signs is preserved through the compositing process, else the relationship between these two signs be lost. This determination of a no parking zone may be then transmitted to parking system 20 for further consideration in the provision of parking availability to subsequent vehicles 11.

Additionally, passing vehicles 10 may detect badging 62, such as a residential badge or the like, which might reflect a vehicle with special parking privileges that transcend existing parking rules. For example, the parking system 20 may expect or otherwise predict, further to the above, that a vehicle 10 parked in a metered parking location 52e will only remain in the metered parking location 52e for the maximum two hours permitted by the parking meter 36. However, exceptions may exist for local residents, businesses, or the like, whereby appropriately designated vehicles – such as with badging 62 or the like – may ignore these sorts of maximums. Accordingly, upon detection of this type of badging 62 vehicle on a parked vehicle 10 by a passing vehicle 10, this information may be conveyed to the parking system 20 so that the parking system may suitably update its expectations or predictions such that the badged vehicle 10 may remain in the metered parking location 52e longer than the expected two hours, thereby impacting the potential availability of the parking location 52e.

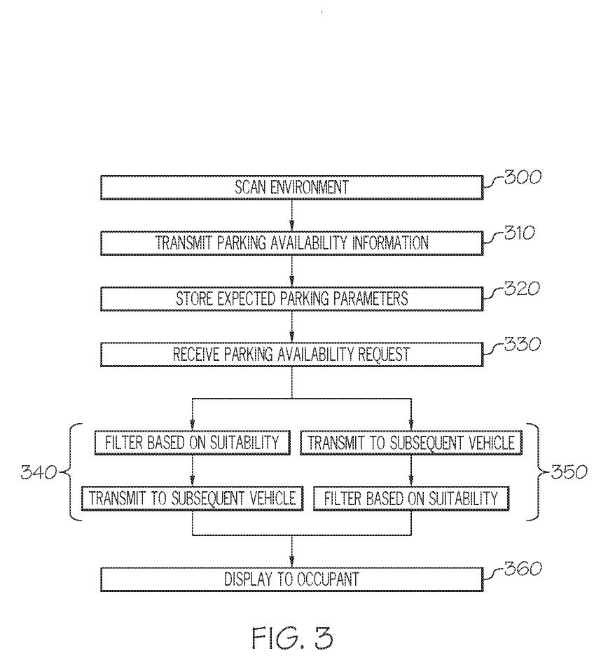

Turning now to FIG. 3, an exemplary process chart for managing parking information/availability is presented.

In step 300, one or more vehicles 10 may use sensors 12 to scan an area for parking-related information and/or parking availability. As discussed above, this information may include details as to the location of a given parking spot, the dimensions of a giving parking spot, whether the parking spot is occupied, signage relevant to the parking spot and/or corresponding rules, regulations, and/or impacts upon parking availability conferred by said signage, vehicle identifying information (e.g., a license plate, visible badging, wireless MAC address or similar, vehicle make, vehicle model, vehicle color, vehicle configuration, current state of the vehicle, and the like) relating to a parked vehicle, and so on. The vehicles 10 may also receive parking-related information and/or parking availability from infrastructure systems 30, or vice versa. In a similar manner to that discussed above for the one or more vehicles 10, the infrastructure system(s) may use sensors 32 to likewise collect parking-related information and/or parking availability.

In step 310, the parking-related information and/or parking availability may be communicated from the vehicles 10 and/or the infrastructure systems 30 to the parking system 20, either directly or indirectly, as update information. For example: the update information may be transmitted from an infrastructure system 30 to a vehicle 10, and then from the vehicle 10 to the parking system 20; the update information may be transmitted from a vehicle 10 to an infrastructure system 30, and then from the infrastructure system 30 to the parking system 20; update information may be transmitted from a vehicle 10 to the parking system 20; update information may be transmitted from an infrastructure system 30 to the parking system 20; update information may be transmitted from any of a vehicle 10 or infrastructure system 30 to a mobile device 40 and/or any other edge computing device or server, and then from the mobile device 40 and/or any other edge computing device to the parking system 20; without limitation. The update information may include at least an expected size of a first of one or more parking locations 52.

In step 320, the parking system 20 may store and/or may have stored information relating to one or more parking locations 52. This stored information may include details such as the dimensions of the parking locations (e.g., length, width height, and other metrics as discussed above) reflected as an expected size of the parking locations, rules relating to time-based parking availability for the locations, exceptions for appropriately badged vehicles, and the like.

In step 330, the parking system 20 may receive from a subsequent vehicle a request for parking availability in a given area. This parking availability request may optionally include information relating to the subsequent vehicle 11, such as the dimensions of the subsequent vehicle and/or the make, model, year, vehicle identification number, and/or other identifying information relating to the vehicle.

In step 340, the parking system 20 may discern a list of possibly available parking locations to transmit to the subsequent vehicle 11 and then filter this list based on whether the dimensions of the subsequent vehicle 11 so received would fit within an expected and/or effective size of a given parking location before sending the parking availability information to the subsequent vehicle 11. As noted above, the dimensions of the subsequent vehicle 11 may be obtained by the parking system 20 directly from the subsequent vehicle 11 as part of the request for parking availability or indirectly by way of vehicle identifying information provided within the requested for parking availability. As also noted above, the list may further be filtered based on a user profile 60 relating to parking preferences. As also noted above, filtering may be conducted based on any representation of the shape, size, and/or dimensions of the expected and effective sizes 54 of the parking location 52.

Alternatively, in step 350, the parking system 20 may simply transmit the list of possibly available parking locations to the subsequent vehicle 11 such that any filtering of the list before presentation to an occupant is conducted by the subsequent vehicle. Again, preferences of the occupant stored within a user profile 60 may be accounted for in the filtering, and any representation of the shape, size, and/or dimensions of the expected and effective sizes 54 of the parking location 52 may be considered.

As also discussed above, the effective size 54 may be smaller or larger than the expected size of the parking location 52. Alternatively, it may be the case that no obstruction or modification is present, at which point the effective size 54 would equal the expected size. In such a case, the parking system 20 may record and store the effective size 54 despite any redundancy or may only record/store the effective size 54 when it differs from the expected size.

Finally, in step 360, the parking availability information and/or filtered list of parking availability may be displayed to an occupant of the subsequent vehicle 11 for selection.

The parking availability information provided to subsequent vehicles 11 may then be used as part of route guidance, navigation, or the like. For example, after identifying a parking location, guidance and/or navigation of the vehicle 11 may direct the occupant to drive towards the parking location so identified.

All of the forms of parking availability information discussed above may optionally be filtered based on an occupant’s preference, user profiles 60, or vehicle type. For example, if the occupant is in a larger vehicle which may have difficulty using on-street parking, on-street parking may be filtered from the parking availability information provided to the subsequent vehicle 11.

It should now be understood that embodiments of the present disclosure are directed to systems and methods networked parking solutions.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

It is noted that the terms “substantially” and “about” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system for managing parking availability, comprising:
a parking system including at least one processor,
wherein the parking system is configured to:
store information relating to a first parking location, the information comprising at least an expected size of the first parking location,
receive update information relating to an effective size of the first parking location, wherein the effective size is different from the expected size, and
transmit to a first vehicle an availability of the first parking location, the availability of the first parking location comprising at least one of the effective size and a determination as to whether the first vehicle will fit within the effective size.

2. The system according to claim 1, wherein the effective size is smaller than or larger than the expected size.

3. The system according to claim 2, wherein the effective size is smaller than the expected size due to an obstruction of the first parking location.

4. The system according to claim 1, wherein the parking system is further configured to:
receive, from a second vehicle, at least one image, the at least one image depicting at least two separate parking signs,
composite the at least two separate parking signs while preserving a relative positional relationship between the at least two separate parking signs, and
determine, from the composite, any impact to the availability of the first parking location of the at least two separate parking signs.

5. The system according to claim 1, further comprising a second vehicle which is configured to measure the effective size and transmit the effective size to the parking system.

6. The system according to claim 5, wherein the second vehicle comprises a time-of-flight measurement system, and the time-of-flight measurement system is used to measure the effective size.

7. The system according to claim 5, wherein the second vehicle comprises a camera, and the camera is used to measure the effective size.

8. The system according to claim 1, wherein, upon receipt of the parking availability, the first vehicle determines whether the first vehicle will fit within the effective size.

9. The system according to claim 1, wherein the parking system is further configured to receive from the first vehicle a request for available parking locations.

10. The system according to claim 9, wherein the request includes vehicle information relating to the first vehicle from which the parking system may, directly or indirectly, ascertain a size of the first vehicle.

11. A method for managing parking availability, comprising the steps of:
storing information relating to a first parking location, the information comprising at least an expected size of the first parking location,
receiving, by a parking system including at least one processor, update information relating to an effective size of the first parking location, wherein the effective size is different from the expected size, and
transmitting to a first vehicle an availability of the first parking location, the availability of the first parking location comprising at least one of the effective size and a determination as to whether the first vehicle will fit within the effective size.

12. The method according to claim 11, wherein the effective size is smaller than or larger than the expected size.

13. The method according to claim 11, further comprising the steps of:
receiving, by the parking system and from a second vehicle, at least one image, the at least one image depicting at least two separate parking signs,
compositing the at least two separate parking signs while preserving a relative positional relationship between the at least two separate parking signs, and
determining, from the composite, any impact to the availability of the first parking location of the at least two separate parking signs.

14. The method according to claim 11, further comprising the steps of:
measuring, by a second vehicle, the effective size; and
transmitting the effective size to the parking system.

15. The method according to claim 14, wherein the second vehicle comprises a time-of-flight measurement system, and the time-of-flight measurement system is used to measure the effective size.

16. The method according to claim 14, wherein the second vehicle comprises a camera, and the camera is used to measure the effective size.

17. The method according to claim 11, wherein, upon receipt of the parking availability, the first vehicle determines whether the first vehicle will fit within the effective size.

18. The method according to claim 11, further comprising the step of:
receiving, by the parking system, a request for available parking locations from the first vehicle, wherein the request includes vehicle information relating to the first vehicle from which the parking system may, directly or indirectly, ascertain a size of the first vehicle.

19. A vehicle, comprising:
at least one sensor,
wherein the vehicle is configured to:
use the at least one sensor to scan an area to generate sensor data relating to parking availability in the area, wherein the sensor data describes an effective size of a first parking location; and
transmit the sensor data to a parking system.

20. The vehicle according to claim 19, wherein the effective size is smaller than or larger than an expected size of the first parking location.
